(19) United States
(12) Patent Application Publication
(10) Pub. No.: US 2026/0346527 A1
(43) Pub. Date: Nov. 5, 2026

(54) MODULAR PRODUCTION SYSTEM AND METHOD FOR DESIGNING A PRODUCTION SYSTEM

(71) Applicant: COPERION GMBH, Stuttgart (DE)

(72) Inventors: Michael BRANZ, Eberhardzell (DE); Michael DÜRR, Wolfegg (DE); Timo ISENMANN, Tettnang (DE); Klaus MENNA, Tomball, TX (US); Holger RISCH, Berg (DE); Hagen SINGE, Stuttgart (DE)

(21) Appl. No.: 19/124,630

(22) PCT Filed: Apr. 25, 2025
(86) PCT No.: PCT/EP2023/077420

§ 371 Date: Apr. 25, 2025

(30) Foreign Application Priority Data
Oct. 26, 2022 (DE) 10 2022 128 404.2

(51) Int. Cl. B29C 48/025; B29C 48/25; B29C 48/265

(52) U.S. Cl. CPC B29C 48/025; B29C 48/256; B29C 48/265

(57) ABSTRACT

The invention relates to a modular production system (100, 400) for processing material by means of extrusion, comprising a plurality of function modules (418-440) and a three-dimensional framework (402) in a grid construction for receiving the function modules (418-440), wherein the grid (202, 302) of the three-dimensional framework (402), in particular the grid dimensions thereof, is specified, at least in some sections, in accordance with the spatial dimensions of the function modules (418-440) and/or in accordance with the relationships and/or arrangement and/or alignment of the function modules (418-440) with respect to one another. The invention further relates to a method for designing a production system (100, 400) for processing material by means of extrusion, said method having the following steps: specifying (S1) requirements, in particular process and/or method requirements, for a system concept for the production system (100, 400) to be planned; selecting (S2) a plurality of function modules (418-440) based on the specified requirements; defining (S3) a grid (202, 302), in particular a system grid and/or building grid, taking into account the specified requirements and/or spatial dimensions of the selected function modules (418-440) and/or the relationships and/or arrangement and/or alignment of the selected function modules (418-440) with respect to one another; and arranging and/or aligning (S4) the selected function modules (418-440) on the defined grid (202, 302).

The invention relates to a modular production system, in particular for processing material by means of extrusion. The invention also relates to a method for designing a production system, in particular a production system for processing material by means of extrusion.

The design and configuration of production systems and their plant buildings must take into account the specific framework conditions and requirements that apply to the respective production system. Production plants must also be adapted to the respective needs of an operator and, if necessary, to their specifications. In particular, production systems for processing material by means of extrusion are usually individually configured and adapted systems that require a large number of different trades and system components, such as extruder units, conveyor equipment or dosing and weighing technology. For each project, a new system and the associated process building with its supply and connections must be planned. Furthermore, plant planning, production planning, process planning, operating costs and logistics often have an important part to play in such large-scale plants. A large number of specialist companies are typically entrusted with the task, and they must work together closely and for long periods of time and be coordinated in order to configure such a production system. The various companies must also provide the data and information that are significant for them.

It has been found that an optimal realisation or adaptation and/or alignment of the production system to the respective production process is not possible, since the arrangement of the individual plant components and/or function modules in particular is not taken into account, or this is also no longer possible due to the three-dimensional frameworks that have already been planned or completed. This can result in distances between individual plant components or function modules being too large or too small, for example, so that they are no longer able to satisfy the optimal process requirements. Individual and optimal coordination of the system components and the associated system peripherals to the respective process requirements is not possible with conventionally planned and designed production systems. In particular, the three-dimensional framework of the production system is configured without taking system-specific or process-optimised processes into account. The system components and function modules to be built later then often have to be adapted subsequently, and it may even be necessary to change their location in the three-dimensional framework, at a cost of much money and time. Optimal coordination of the various function modules with one another cannot be achieved in this way. Finally, more and more space-saving but also ecologically and economically conscientious construction methods are required, which cannot be achieved with conventional production systems or the known design of such systems.

For example, DE 10 2009 052 748 B4 discloses a container compounding plant with a frame-like framework enclosing at least one process chamber and with a subframe arranged in the process chamber that can be securely attached to the framework for transport.

Further, DE 10 2008 037 011 A1 discloses an extrusion system with an extruder and a screen changing device, wherein the extrusion system has a three-dimensional supporting structure that is designed to accommodate the extruder and the screen changing device.

The object underlying the invention is that of structurally and/or functionally improving a production system as described in the introduction. The invention is also based on the further object of structurally and/or functionally improving a method as described in the introduction for designing a production system.

In particular, it is an object of the present invention to provide a production system or a method for designing a production system that can reduce or eliminate the problems identified in connection with the prior art. For example, it is an object to enable optimal positioning of the components and/or function modules relative to one another and optimal configuration and/or adaptation and/or alignment thereof to the respective production process. Another task is to reduce the plant expenditure, planning expenditure and/or planning time, in particular the investment costs but also the operating costs for a production system.

The object is achieved with a modular production system having the features of claim 1 and/or 26. The object is also achieved with a method for designing a production system having the features of claim 18. Advantageous variants and/or further developments are the subject matter of the subclaims, the description and/or the accompanying figures. In particular, the independent claims of a claim category can also be developed and/or combined similarly to the dependent claims of another claim category. Apparatus and method features described below may also be combined and/or developed in combination with each other.

A production system may be a modular production system. The production system may be used to process material by means of extrusion and/or it may be or may have been designed and/or configured for that purpose. The production system may be or comprise an extrusion plant and/or a compounding plant or may be or may have been designed and/or configured for that purpose. The production system may be or comprise a plant for processing, for example transporting and/or dosing, bulk material, for example a bulk material plant, and/or it may be or may have been designed and/or configured for that purpose. The production system may be or comprise a food extrusion plant and/or it may be or may have been designed and/or configured for that purpose. The material to be processed may be, for example, organic and/or inorganic bulk material. The bulk material may be a fine-grained bulk material, for example powder. The material to be processed may be or comprise plastic. Alternatively, the material to be processed may be or comprise an organic material, for example food or food product or animal feed. The material to be processed may also be an organic bulk material and/or cellulose material. The material to be processed may be or contain a bioplastic, for example a bioplastic obtained from a melt. The material to be processed may further be or contain a compound material, for example a wood compound and/or fibre compound. The wood compound may contain wood fibres. The compound material may include a plastic material and an organic and/or mineral material.

For example, the material to be processed may be a material to be recycled, such as plastic material. The plastic material may be recycled ground material or recycled bulk material. The plastic may be or comprise, for example, polyolefin, in particular polypropylene (PP) and/or polyethylene (PE). The polyethylene may be a low-density polyethylene (LDPE), a linear low-density polyethylene (LLDPE) or a high-density polyethylene (HDPE). Polyolefins may be polyolefins with low melting points, in particular ethylene-vinyl acetate copolymers (EVA) or cross-linked polyethylene (XLPE). The plastic may also be or comprise a polyvinyl chloride (PVC), for example PVC from emulsion polymerisation (E-PVC), from suspension polymerisation (S-PVC) and/or from mass polymerisation (M-PVC). The plastic may also be or comprise a PVC dry blend. In addition, the plastic may be an engineering plastic, such as polyamide (PA), polycarbonate (PC), polyethylene terephthalate (PET).

The production system may comprise at least one function module. The production system may comprise a plurality of function modules. The function modules may have and/or define spatial dimensions. The spatial dimensions of the function modules may include a length, a width and/or a height.

The production system may comprise a three-dimensional framework. The three-dimensional framework may be or may have been designed and/or configured to be or become part of a building, such as a hall or production hall, and/or to be or may have been constructed and/or integrated in a building. The three-dimensional framework may serve to accommodate the function modules, in particular be designed and/or configured for such purpose. The three-dimensional framework may be or comprise a steel supporting structure and/or a concrete supporting structure and/or a wooden supporting structure. The three-dimensional framework may include vertical and/or horizontal supports or support elements or struts. The three-dimensional framework and/or its beams or struts may be or may have been made of steel. Additionally or alternatively, the three-dimensional framework and/or its beams or struts may be or may have been made of concrete and/or reinforced concrete and/or wood. For example, it may be a structure made exclusively from steel or concrete, or a combined structure.

The three-dimensional framework may be in a grid construction, in particular designed and/or configured for that purpose. The three-dimensional framework may include and/or define a grid. The three-dimensional framework and/or its grid may have and/or define dimensions or grid dimensions. The dimensions or grid dimensions may have and/or define a grid height, grid length and/or grid width. The grid may be a three-dimensional grid. The grid may be a Cartesian/orthogonal grid. The grid may define and/or have a Cartesian/orthogonal coordinate system. The grid may have three directions or directional axes that may be orthogonal to each another. At least sections of the grid and/or the grid dimensions may be or be defined according to the relationships and/or arrangement and/or alignment of the function modules to one another and/or relative to each other. The relationships of the function modules to one another and/or relative to each other may be understood to be, for example, a functional relationship, a line flow relationship and/or a material flow relationship. The functional relationship may be understood to be a functional connection and/or a necessary relationship between function modules, for example a force transmission relationship, such as a drive force transmission relationship, or a material transfer relationship or the like. The functional relationship may also be understood to be the function-defined and/or effective arrangement and/or alignment of the function modules with respect to one another. The line flow relationship may be understood to be the flow of auxiliary and/or operating materials/working materials, such as conveying air, flushing gases, water, cleaning agents, etc. The line flow relationship may also be understood to be the routing of lines, such as supply lines, and/or cable runs. The material flow relationship may be understood to be the flow of the material to be processed, for example, the supplied primary material and/or any admixtures/additives. A relationship may also be understood to be a logistical chain. The grid and/or grid dimensions may be or may have been determined according to the function, the line flow, the material flow and/or the logistical chain of the function modules.

Additionally or alternatively, at least sections of the grid and/or the grid dimensions may be or may have been defined according to the function modules that are to be and/or may have been arranged in the three-dimensional framework, in particular according to a requirement for a system concept of the production system. The requirements may be, for example, process and/or procedural requirements for the production system. The requirements may include and/or define the production output and/or production capacity of the production system. The requirements may include and/or define requirements relating to occupational safety. Additionally or alternatively, at least sections of the grid and/or grid dimensions may be or may have been defined according to the spatial dimensions of the function modules. At least sections of the dimensions and/or grid dimensions of the grid may correspond substantially to the spatial dimensions of the function modules.

The dimensions/measurements and/or the grid dimensions of the grid and/or the spatial dimensions/measurements of the function modules may be or may have been designed at least in part as standardised dimensions/measurements or standardised grid dimensions. Standardised dimensions or standardised grid dimensions may be or may have been determined based on and/or depending on the size of functional elements present in the respective function modules, such as subprocess, transmission, motor, etc., and/or based on and/or depending on the requirements that apply to the production system. Standardised dimensions or standardised grid dimensions may have been or may be determined based on sizes specified by standards or guidelines. Additionally or alternatively, standardised dimensions or standardised grid dimensions may have been or may be determined based on standardised sizes of trades and/or function modules. The standardised dimensions or standardised grid dimensions may be and/or define standardised container dimensions. At least one or all of the function modules may have and/or define standardised dimensions, such as heights, lengths and/or widths. The standardised dimensions or standardised grid dimensions may have and/or define standardised lengths, widths and/or heights. A standardised height may be for example approx. 6.0 to 10.0 m, preferably approx. 8.0 m, or approx. 3.0 to 5.0 m, preferably approx. 3.5 m. A standardised length may be for example approx. 6.0 to 12.0 m, preferably approx. 8.0 m or approx. 10.0 m. The lengths, as standardised lengths, may be identical in a core area and in a secondary area. The same lengths may thus be or may have been provided in the core area and in the secondary area. A standardised width may be for example approximately 4.0 to 12.0 m, preferably approximately 10 m (e.g. in a core area) or approximately 6.0 m (e.g. in a secondary area). The widths, as standardised widths, may be different in a core area and in a secondary area. Different widths can therefore be provided in the core area and in the secondary area.

The grid may have multiple grid units. The grid units may be and/or define container units. The grid units may be or may have been designed in the shape of a square, a rectangle, a cube or cuboid, and/or a container. The grid may have identical grid units at least in sections. The grid units may all be substantially the same. The grid units may each have a grid length, grid width and grid height. The grid length, grid width and/or grid height of at least one grid unit may substantially correspond to the spatial dimension of a function module arranged in the grid unit. The grid length, grid width and/or grid height of at least one grid unit may substantially correspond to the spatial dimension of many, for example most arranged function modules. The grid lengths, grid widths and/or grid heights of many, such as most grid units, may each substantially correspond to the spatial dimension of the function module arranged in the respective grid unit. The grid length and/or grid width may be or may have been determined depending on the function module. The grid height may be or may have been determined for structural reasons. The grid units may have a supporting structure, such as a three-dimensional framework. It may also be or may have been provided that not every grid unit has a supporting structure. This means that a supporting structure does not have to be or may have been arranged in every grid unit.

The grid may include a plurality of grid units, each having a grid length, grid width and grid height, wherein the grid lengths and/or grid widths of grid units arranged one above the other in the height direction, for example substantially vertically one above the other, are all substantially the same and/or substantially correspond to the length and/or width of the function module with the greatest length or width arranged in this height direction.

At least one function module may extend substantially over one, two or more grid units. For example, at least one function module may extend substantially over a multiple, e.g. approximately 0.5, 0.8, 1.5, 1.8 or 2.0 times, of the length and/or width and/or height of the respective grid unit. Additionally or alternatively, the length and/or width of the grid units may differ at least in sections from grid unit to grid unit. For example, at least one grid unit may extend over one, two or more other, for example neighbouring, grid units. For example, at least one grid unit may extend substantially over a multiple, e.g. approximately 0.5, 0.8, 1.5, 1.8 or 2.0 times the length and/or width and/or height of another, for example neighbouring, grid unit.

The three-dimensional framework and/or its grid may have a first, for example lowest, level with a first minimum height, for example minimum grid height. The three-dimensional framework and/or its grid may have at least one second level arranged on and/or built on the first level with a second minimum height, for example minimum grid height. Level may also be understood to be an area, such as a level area, or a storey of a building. The first minimum height of the first level may be greater than the second minimum height of the at least one second level. Several second levels arranged and/or constructed one on top of the other may be or may have been provided. For example 2 to 8 second levels may be or may have been provided. The plurality of second levels may all have the same second minimum height. The plurality of second levels may at least partially have the same second minimum height. That is to say, a plurality of second levels may be provided, some having the same second minimum height and others having a different second minimum height. The plurality of second levels may also all have different second minimum heights. The first minimum height of the first level may be about 6.0 to 10.0 m, preferably about 8.0 m. The second minimum height of the at least one second level may be about 3.0 to 5.0 m, preferably about 3.5 m.

The function modules may be or may have been selected and/or provided according to the requirements and/or the purpose of the production system. The function modules may, for example, comprise at least one function module from, in particular selected from, the following group: silo module, additive lift module, additive delivery module, additive dosing module, drivetrain module, transmission module, subprocess module, pressure boosting system module, granulation module, start-up system module, hot oil module, granulation water system module, granulate drying module, granulate screening module, granulate buffer container module, granulate removal module, maintenance module. At least one line module for providing connecting lines between modules and/or at least one connection module for providing functional connections between modules may also be or may have been provided. The production system may also have several identical (e.g. several subprocess modules) or at least substantially similar function modules and/or may be or may have been selected according to the requirements and/or the purpose of the production system.

The at least one silo module may be a feed silo module and/or a powder feed silo module and/or a bulk material storage container module. The silo module may have at least one storage container, such as a bulk material storage container and/or a powder storage container. The at least one storage container may be a silo, such as a bulk material silo and/or a powder silo. The silo may be a day silo. The silo module may include several storage containers. The silo module may include at least one or more, e.g. two, storage containers/silos, such as storage silos. The at least one storage container/silo may serve and/or be designed as a buffer volume for the bulk material. The bulk material may be a fine-grained bulk material, for example powder, e.g. polymer powder. The at least one storage container/silo may have an outlet. The at least one storage container/silo and/or its outlet may be connected to at least one additive dosing module and/or subprocess module, in particular in such a way that the bulk material from the at least one storage container/silo can reach or be conveyed to the at least one additive dosing module and/or subprocess module. The at least one silo or the at least one storage container may be connected to a subprocess module via a downpipe and/or a mechanical transport element/conveying element. The storage containers/silos may each be connected to a subprocess module via separate downpipes.

The at least one additive lift module may be designed to transport additives or admixtures to an additive delivery module. Additives may be brought in (additive) transport units, such as individual receptacles, typically called big bags (BB) or super sacks or FIBCs, alternatively in small transport containers as pallets with sacks from an additive warehouse at ground level to the production system, for example by means of a lift truck, such as a forklift. From there, transport to the additive delivery module may be carried out by means of a conveying apparatus of the additive lift module. The at least one additive lift module may have at least one conveying apparatus. The at least one conveying apparatus may be arranged inside or outside the additive lift module. For example, the at least one conveying apparatus may be arranged on an outer wall of the additive lift module and/or the building. The at least one conveying apparatus may be a lifting device, for example an elevator, such as a freight elevator, or a crane. Alternatively, at least one conveying device, for example a pneumatic conveying device, may be provided in the additive lift module. The at least one conveying device may be designed to transport or convey additives from outside the building/the production system into the additive delivery module. The pneumatic conveying device may be designed as a suction conveyor or pressure conveyor. The at least one additive lift module may extend over several levels, in particular in the vertical direction.

The at least one additive delivery module may have at least one discharge station, such as an emptying station, and/or at least one intermediate storage facility. The at least one discharge station may be a mobile storage container, which are also called Flexible Intermediate Bulk Containers (FIBC). Within the additive delivery module, the additives may typically be supplied and/or emptied as (additive) transport units, such as big bags (BB)/super sacks/FIBCs. The additives may also be supplied in the form of bagged goods, barrels or in transportable intermediate containers, such as premix containers (e.g. in the case of in-house premix manufacture). The at least one additive delivery module may be designed to lift the (additive) transport units into the at least one emptying station and/or to connect them to at least one feed opening of the additive module system or an additive dosing module. Additionally or alternatively, the additives may be transported or conveyed from outside the building/production system into the additive delivery module via at least one, in particular pneumatic, conveying device. In this case, a container with a built-in filter, such as a total separator, may be provided instead of the emptying station. In one embodiment, the total separator may be functionally combined with the buffer container, i.e. the boundary between the additive delivery module and the additive dosing module may substantially pass through the container or total separator. The pneumatic conveying device may be designed as a suction conveying device or a pressure conveying device.

Additives may be in particular admixtures and/or supplements such as colour pigments, stabilisers, antiblocking agents, processing aids, stearates, titanium dioxide, plasticisers and/or whiteners in order to influence the properties of the material to be processed. The additives may be bulk material. The additives may be in powder or granular form, for example.

The at least one additive dosing module may comprise at least one additive dosing apparatus. The at least one additive dosing apparatus may be designed to dispense the additive in doses from the at least one additive delivery module in measured doses. The at least one additive dosing module or at least one additive dosing apparatus may have at least one buffer container. The buffer container may have a size adapted to the process or requirements. The at least one additive dosing apparatus may have at least one screw, such as a dosing screw, and/or at least one downpipe. The at least one additive dosing apparatus may be indirectly or directly connected to the subprocess module. The at least one additive dosing apparatus may supply a defined amount of additive to the material flow according to a predetermined recipe depending on the material flow to be processed. The at least one additive dosing apparatus may feed the additive via, for example, substantially vertical downpipes from above into a transport element or into a transport unit onto the material to be processed and/or discharge it there. The transport element or the transport unit may be a vertical or inclined downpipe and/or a conveyor screw and/or a mixing screw. The mixture of additive and material to be processed may be transferred to the subprocess module at the end of the transport element/transport unit via a downpipe, e.g. by gravity.

The at least one drivetrain module may be a motor module. The at least one drivetrain module may include at least one drivetrain. The at least one drivetrain may be designed according to a transmission design of the transmission module. The at least one drivetrain module may include at least one motor, e.g. drive motor. The bearings of the at least one motor may be cooled and/or lubricated via a lubricating oil system. The at least one motor may be connected to the transmission of the transmission module via a mechanical coupling. The drive or motor may be cooled via a central cooling water circuit and/or an integrated heat exchanger and/or a fan.

The at least one transmission module may include at least one transmission, such as a main transmission. The at least one transmission module may be a main transmission module. The at least one transmission may be driven via the at least one drivetrain module or the at least one motor of the drivetrain module. The at least one transmission module and/or at least one transmission may pass on or transmit the force, such as driving force and/or torque, to a subprocess module and/or to its components/subprocess. The at least one transmission may be encapsulated with a soundproof housing, in particular to prevent noise from propagating to the outside. The at least one transmission module may also have an area or area for maintenance. This means that sufficient storage space may be provided in the event of maintenance, for example for the large and/or heavy components of the transmission.

The at least one subprocess module may include at least one subprocess. The at least one subprocess module may have at least one storage container for charging the at least one subprocess. The subprocess may be designed to draw in the supplied material via a screw, e.g. a double screw, and to melt it using the force from the transmission module and/or drivetrain module. The subprocess may be heated using different systems, for example by a heating device, e.g. using hot oil, steam, or electrically. Distribution batteries may be installed, in particular to the left or right of the subprocess, to distribute the steam or hot oil. The heating device may be connected to a hot oil module and/or be or may have been temperature controlled, such as heated, by means of the hot oil module. The subprocess may be or comprise a screw machine. The screw machine may have at least one feed opening for feeding the material to be processed and/or the additives. In addition, the screw machine may have at least one further feed opening for feeding an additive. For example, the at least one additive dosing module may feed the material to be processed and/or the additives via the at least one feed opening of the screw machine. The at least one subprocess module and/or the at least one screw machine may have at least one feed device and/or dosing device for feeding the material to be processed and/or the additives and/or a mixture thereof. The at least one screw machine may include at least one hopper, such as a filling hopper, for feeding the material to be processed and/or the additives and/or a mixture thereof. The at least one screw machine may be designed to melt and/or plasticise the material fed into it. The at least one screw machine may be drivable by the motor of the drivetrain module. The at least one screw machine may be designed as a multi-shaft screw machine, in particular a twin-shaft screw machine. The screw machine may be an extruder, in particular a multi-shaft extruder such as a twin-screw extruder. The at least one subprocess module may be an extruder module. The at least one subprocess module may include one or more subprocesses. The at least one subprocess may be an extruder. The at least one subprocess module may, and/or the at least one subprocess thereof may have at least one side extruder. A side extruder module with at least one side extruder may be provided. Several subprocesses, each with its own drive and/or transmission module, may be connected to one another. For example, two screw machines may be connected to one another in such a way that one screw machine can transfer or supply melted material to the subsequent screw machine. The at least one subprocess module may have a cooling device, such as a cooling water battery, which is designed to cool the subprocess. The cooling water may be supplied in a closed circuit as demineralised water, e.g. in a SKID unit. The at least one screw machine may have a discharge opening, in particular at its downstream end, for example at the downstream end of a discharge zone. The discharge opening may be designed in such a way that the processed melt, such as plastic melt, may be discharged from the interior of the screw machine through it. A pressure boosting system module or pressure boosting part of the pressure boosting system module may be connected to the discharge opening. The melt or mixture processed in the screw machine may be fed as melt the pressure boosting system module or a pressure boosting part of the pressure boosting system module.

The at least one pressure boosting system module may include at least one pressure boosting part. The at least one pressure boosting part may be a pump, such as a melt pump. The at least one pressure boosting part and/or the melt pump may be designed to generate pressure or a pressure boost and/or to apply pressure to the melt, such as plastic melt. The at least one pressure boosting part and/or the melt pump may be a gear pump and/or positive displacement pump. The at least one pressure boosting system module may be a melt pump module. The at least one pressure boosting system module may have at least one temperature control unit for the pressure boosting part or the melt pump, in particular for its bearings and/or shaft. The at least one temperature control unit may be connected to a hot oil module and/or may be temperature controlled, such as heated, by means of the hot oil module. The at least one pressure boosting system module may have at least one valve, for example a start-up valve and/or throttle valve. The at least one pressure boosting system module may have at least one screen changing device and/or a perforated plate. The subprocess or the discharge opening of the subprocess of the subprocess module may open into the start-up valve at its downstream end in the conveying direction. The pressure boosting part may be arranged downstream of the start-up valve in the conveying direction. The pressure boosting part may open into the screen changing device. The material melted in the subprocess may be or may have been forwarded to the start-up system module via the start-up and/or throttle valve when production starts. The material may be or may have been forwarded to the screen changing device by switching the start-up and/or throttle valve in the direction of production, in particular after a predefined product quality has been achieved. The screen changing device may be designed to filter the material. The perforated plate may be arranged downstream of the screen changing device. After the perforated plate, the material pressed through the perforated plate may be or will be transferred to a granulation module.

The at least one granulation module may be an underwater granulation module. The at least one granulation module may have at least one movable carriage. The at least one movable carriage may be arranged so that it can be moved on a rail. The rail may be embedded in the floor of the granulation module and/or of the building in which the production system is arranged. The rails may be or may have been extended using rail extensions. The at least one granulation module may have at least one granulation apparatus. The granulation apparatus may be arranged on the movable carriage. The granulation apparatus may be docked and/or undocked to the pressure boosting system module or to the perforated plate thereof by means of the movable carriage. The docked state may represent a production mode. The undocked state may represent a maintenance mode. The granulation apparatus may be arranged downstream of the perforated plate of the pressure boosting system module and/or connected thereto. Alternatively, the granulation apparatus may include the perforated plate. The granulation apparatus may be designed and/or intended for granulating material strands, such as plastic material strands. The granulation apparatus may include a pelletiser hood. The granulating apparatus may include a water inlet line, in particular one that opens into the pelletiser hood. The granulating apparatus may have a water-granulate outlet line, in particular one that opens out of the pelletiser hood. The granulating apparatus or its pelletiser hood may be connected to a granulating water system module, in particular via the water inlet line and/or the water-granulate outlet line. For an emptying process, for example during undocking, a drain line, e.g. channel, may be provided to drain the granulating water from the pelletiser hood.

The at least one start-up system module may be a collecting module. The at least one start-up system module may have at least one container, such as a collecting container or collecting basin. The at least one start-up system module may have at least one cutting device. The at least one start-up system module may have at least one discharge line. The discharge line may be designed as a channel. The discharge line may be connected to the start-up and/or throttle valve of the granulation module and/or to the at least one cutting device. The discharge line may be designed and/or configured to discharge the material comminuted by the cutting device, in particular to flush it into the at least one container. The container may serve and/or be designed as a storage container for the required flushing water of the discharge line.

The at least one hot oil module may be a hot oil unit module. The at least one hot oil module may include at least one hot oil unit. The at least one hot oil unit may be designed to control the temperature and/or heat heating devices and/or temperature control devices of other modules, for example the subprocess module and/or the pressure boosting system module. For example, one hot oil unit may be provided for the subprocess module and another hot oil unit may be provided for the pressure boosting system module.

The at least one granulation water system module may be designed and/or configured to supply and/or discharge granulation water and/or to transport the material granulated in the granulation module, in particular to the granulate drying module and/or granulate screening module. The at least one granulation water system module may be designed and/or configured to create a circuit, such as a water circuit, in particular between the at least one granulation module and a granulate drying module and/or granulate screening module, for material transport. The at least one granulation water system module may include at least one granulation water container, at least one granulation water pumping station, at least one granulation water temperature control station, at least one granulation water bypass, and/or at least one flow monitor. The granulation water container may include at least one filter unit. Additionally or alternatively, the at least one granulation water system module may comprise a granulation water container module, a granulation water sump module and/or a cooling water module and/or be connected to such a module. The at least one granulation water system module may be designed and/or configured to receive the material granulated in the granulation module by means of the granulation water and to transport it to the granulate drying module and/or granulate screening module.

The at least one granulate drying module may include at least one granulate dryer. The granulate dryer may be designed and/or configured to dry the material granulated by the granulation module. The at least one granulate drying module may include at least one agglomerate separator. The water from the granulate dryer may be or may have been returned to the circuit of the granulation water system module. The at least one granulate drying module may be connected to the at least one granulate screening module.

The at least one granulate screening module may be a granulate classifying module. The at least one granulate screening module may be arranged downstream of the at least one granulate drying module. The at least one granulate screening module may be designed to screen and/or classify the granulate stream according to a certain particle size, for example, in particular after said stream has been dried by the granulate drying module or the granulate dryer thereof. The granulate material or the usable product/granulate may be transferred or transported to a granulate buffer container module, in particular by means of a line such as a channel or downpipe. The material screened out or separated as bad granulate, the “oversize” and “undersize” granulate, may be or may have been fed into collection containers via downpipe(s).

The at least one granulate drying module and the at least one granulate screening module may be designed as a common granulate drying and screening module. This enables at least one granulate drying and screening module to be or may have been provided. The at least one granulate drying and screening module may have the features and/or elements of the at least one granulate drying module and the at least one granulate screening module.

The at least one granulate buffer container module may be a granulate collecting module. The at least one granulate buffer container module may include at least one mass flow measuring device for detecting a mass and/or volume flow of the granulate material (usable granulate) supplied from the granulate screening module or the granulate drying and screening module. The mass flow measuring device may be a mass flow measuring unit. Usable granulate may thus flow from a screening device or classifying device of the granulate screening module or the granulate drying and screening module substantially continuously through the mass flow measuring device. A material throughput, in particular a current one, may be determined by means of the mass flow measuring device or by means of the recorded mass and/or volume flow of the granulate. The at least one granulate buffer container module may include at least one granulate buffer container for the granulate material. The granulate buffer container may be connected to the mass flow measuring device, in particular in such a way that the granulate material can fall from the mass flow measuring device into the granulate buffer container. The at least one granulate buffer container module may include at least one dosing device, e.g. a rotary gate valve. The at least one dosing apparatus may be designed to transfer the granulate material from the granulate buffer container to a granulate removal module or to feed it into a conveyor, in particular a pneumatic conveyor. The granulate buffer container may be used and/or designed to store granulate material temporarily.

The at least one granulate removal module may include at least one conveyor, for example a pneumatic conveyor. The at least one conveyor may be connected to the at least one dosing device of the granulate buffer container module. The at least one conveyor may be designed and/or configured to transport the granulate material fed in from the at least one dosing device of the granulate buffer container module out of the production system and/or the building to at least one mixing and/or bagging silo.

The at least one granulate buffer container module and the at least one granulate removal module may be embodied as a combined granulate buffer and removal module. In this way, at least one granulate buffer and removal module may be provided. The at least one granulate buffer and removal module has the features and/or elements of the at least one granulate buffer container module and the at least one granulate removal module.

The at least one maintenance module may be a placeholder module, for example for a required free space and/or access for maintenance of the respective modules and/or devices. The at least one maintenance module may be an oil maintenance module, motor maintenance module and/or transmission maintenance module. The at least one maintenance module may be designed and/or configured to provide a necessary space/area and/or required lifting gear, in particular for maintenance. The at least one maintenance module may be designed and/or configured to enable access from the outside, for example for making tools and/or spare parts available.

At least one core area may be or may have been provided, or the production system and/or its three-dimensional framework may include and/or define at least one core area. In the at least one core area, the three-dimensional framework may be or may have been reinforced. Reinforced may be understood to denote a corresponding rigidity, such as bending rigidity and/or torsional rigidity, and/or strength and/or load-bearing capacity. Additionally or alternatively, the at least one core area may have a foundation, in particular a reinforced one. At least one secondary area may be or may have been provided, or the production system and/or its three-dimensional framework may have and/or define at least one secondary area. The at least one secondary area may be or may have been provided and/or arranged for example directly/immediately adjacent to the at least one core area. In the at least one secondary area, the three-dimensional framework may be or may have been less reinforced than the three-dimensional framework in the at least one core area. In the at least one core area, the three-dimensional framework may be designed to be more rigid, for example flexurally and/or torsionally more rigid, and/or with greater strength and/or with greater load-bearing capacity, compared to the three-dimensional framework in the at least one secondary area. Additionally or alternatively, the at least one secondary area may have a foundation that is less reinforced than the foundation in the at least one core area. In the at least one core area, the foundation may be or be designed to be stronger and/or have a higher load-bearing capacity than the foundation in at least one secondary area. For example, the foundation in at least one core area may be or include a thicker floor slab than the foundation in at least one secondary area and/or have more steel inserts/reinforcements. At least one external area may be or be provided, or the production system and/or its three-dimensional framework may have and/or define at least one external area. The at least one external area may be or may have been provided and/or arranged for example directly/immediately adjacent to the at least one core area and/or the at least one secondary area. A three-dimensional framework may not be or may have been provided and/or arranged in the at least one external area.

In the at least one core area, at least one or more function modules may be or may have been arranged, selected from the following group: silo module, additive delivery module, additive dosing module, drivetrain module, transmission module, subprocess module, pressure boosting system module, granulation module, granulate drying module, granulate screening module, granulate buffer container module, granulate removal module. The function modules may be or may have been arranged in the at least one core area according to their function and/or relationship to one another. For example, a drivetrain module, transmission module and subprocess module may be or may have been arranged in a row and/or in one level (for example the first and/or lowest level), in particular one directly after the other. In the at least one core area, heavy-duty function modules and/or force-introducing function modules and/or function modules presenting a risk of explosion may be or may have been arranged and/or grouped, for example in the lateral direction substantially directly next to or adjacent to one another and/or in the vertical direction substantially one above the other.

In the at least one secondary area, at least one or more function modules may be or may have been, selected from the following group: additive lift module, additive delivery module, additive dosing module, subprocess module, pressure boosting system module, granulation module, hot oil module, granulation water system module, granulate drying module, granulate screening module, granulate buffer container module, granulate removal module, maintenance module. The function modules may be or may have been arranged in at least one secondary area according to their function and/or their relationship to one another. For example, an additive lift module may be or may have been arranged adjacent to an additive delivery module and/or a granulate drying module adjacent to a granulate screening module.

At least one or more function modules may be arranged in the at least one external area, selected from the following group: additive delivery module, start-up system module, hot oil module, granulation water system module. The function modules may be or may have been arranged in the at least one external area according to their function and/or relationship to each another.

The respective function modules may also be or may have been arranged across areas, for example from the core area to the secondary area or from the secondary area to the external area, according to their function and/or relationship to each other. In particular, function modules that are close to the area boundary of two areas (e.g. core area and secondary area or secondary area and external area) may be arranged according to their relationship to one another.

At least one or more function modules may be or may have been arranged in the first level, selected from the following group: additive lift module, drivetrain module, transmission module, subprocess module, pressure boosting system module, granulation module, start-up system module, hot oil module, granulation water system module, maintenance module. The function modules may be or may have been arranged in the first level according to their function and/or relationship to one another. For example, a drivetrain module, transmission module and subprocess module may be or may have been arranged in a row in the first level, for example, the lowest level, in particular directly one behind the other, may or will be arranged.

A method may be and/or serve for designing a production system, for example a modular production system. The production system may be or may have been designed and/or configured for processing material by means of extrusion. The production system may be or may have been designed or set up as described previously and/or in the following text. The method may be a method for designing and/or specifying a supporting structure, such as a three-dimensional supporting structure, for example a production system in a grid construction.

The method may comprise the step of: specifying requirements for a system concept of the production system to be planned. The requirements may be, for example, process and/or procedural requirements of the production system. The requirements may comprise and/or define the production output and/or production capacity of the production system. The requirements may comprise and/or define requirements for occupational safety.

The method may comprise the step of: selecting a plurality of function modules based on the specified requirements. The function modules may be or may have been designed as described previously and/or in the following text. The function modules may be or be selected from defined groups of function modules. These may be the groups of function modules described previously and/or in the following text. The function modules may be selected according to the requirement and/or the purpose of the production system.

The method may comprise the step of: defining a grid taking into account the specified requirements and/or spatial dimensions of the selected function modules and/or the relationships and/or arrangement and/or alignment of the selected function modules with respect to one another and/or with each other. The grid may be for example a system and/or building grid. The grid may be the grid of a three-dimensional framework and/or define a three-dimensional framework. The grid may be or may have been designed and/or defined as described previously and/or in the following text. At least sections of the grid and/or the grid dimensions may be specified/defined according to the relationships and/or arrangement and/or alignment of the function modules with respect to one another and/or relative to each other. Relationships of the function modules with respect to one another and/or relative to each other may be understood and/or specified/defined, for example, as a functional relationship, a line flow relationship and/or a material flow relationship. A functional relationship may be understood and/or specified/defined as a functional connection and/or a necessary relationship between function modules, for example a force transmission relationship, such as a drive force transmission relationship, or a material transfer relationship or the like. A functional relationship may also be understood as the function-defined and/or effective arrangement and/or alignment of the function modules with respect to one another. A line flow relationship may be understood and/or specified/defined as the flow of auxiliary and/or operating materials/working materials, such as conveying air, flushing gases, water, cleaning agents, etc. The line flow relationship can also be understood and/or specified/defined as the routing of lines, such as supply lines, and/or cable runs. The material flow relationship may be understood and/or specified/defined as the flow of the material to be processed, for example the primary material and/or any admixtures/additives. The relationship can also be understood and/or specified/defined as a logistics chain. The grid and/or grid dimensions may be specified and/or defined according to the function, the line flow, the material flow and/or the logistics chain of the function modules. The arrangement and/or alignment of the selected function modules may be understood and/or specified/defined as the fact that the selected function modules can and/or should be arranged and/or aligned on the grid accordingly.

The method may comprise the step of: arranging and/or aligning the selected function modules on the defined grid. The functional modules may be or may have been arranged and/or aligned with each other to reflect functional and/or effective considerations.

The grid may be defined in such a way and/or the function modules may be arranged and/or aligned on the defined grid in such a way that the function, such as overall function, of the production system and/or the respective function modules and/or relationships of the function modules with respect to one another is/are realised.

Defining the grid may include determining grid units, each with a grid length, grid width and grid height. The grid length and/or grid width may be determined depending on the function module. The grid height may be determined by structural constraints. Structural constraints may be understood as both design-related building specifications and legal building specifications. Structural constraints may also be understood to be building design and/or structural analysis. Structural constraints may further be understood as pertinent building standards. The grid dimensions and grid length, grid width and/or grid height may be or may have been specified as described previously and/or in the following text.

Additionally or alternatively, defining the grid may include determining multiple levels with minimum heights, for example minimum grid heights. The minimum heights of the levels may be determined by structural constraints, based on the spatial dimension, for example height, of at least one function module provided on the respective level and/or specified and/or defined based on the specified requirements.

Additionally or alternatively, defining the grid may include determining a first level with a first minimum height, for example minimum grid height, and at least one second level with a second minimum height, for example minimum grid height. The first minimum height of the first level may be greater or specified as greater than the second minimum height of the at least one second level. Multiple second levels arranged one above the other and/or built on top of each other may be determined/defined and/or specified. The multiple second levels may all have the same second minimum height. At least some of the plurality of second levels may have the same second minimum height. That is to say, a plurality of second levels may be or may have been provided, some having the same second minimum height and others having a different second minimum height. The plurality of second levels may also all have different second minimum heights.

Additionally or alternatively, defining the grid may include determining a number of height levels. The height distance from one height level to the next height level may be determined and/or defined in such a way that function modules arranged substantially one after the other, for example successively in the height direction, are or can be effectively connected to one another. The height distances of at least three successive height levels may be the same or may be defined identically.

The grid may be determined or defined in the vertical direction, for example from bottom to top or from top to bottom, and/or in the lateral direction, for example from left to right or from right to left. The grid may be determined or defined starting from at least one basic function module. The at least one basic function module may be a drivetrain module, a transmission module, a subprocess module, a pressure boosting system module or a granulation module, and/or a heavy-duty function module and/or a force-introducing function module or may be specified as such. The at least one basic function module may be or may have been placed on the first, for example lowest, level. For example, the at least one basic function module may be a function module having an extruder, such as an extruder module, or a function module having a transmission, such as a transmission module, or a function module having a melt pump, such as a melt pump module or pressure boosting system module or may be defined as such.

The grid may be determined or defined in the height direction and/or lateral direction at least in sections based on the spatial dimensions of the at least one basic function module. Additionally or alternatively, the spatial dimensions of the function modules that are adjacent and/or follow in the vertical and/or lateral direction starting from the at least one basic function module may be determined or defined at least in sections based on the spatial dimensions of the at least one basic function module. It can be determined whether the respective spatial dimensions of the function modules that are adjacent and/or follow in the vertical and/or lateral direction starting from the at least one basic function module are smaller than the spatial dimensions assigned to the respective vertical and/or lateral direction of the at least one basic function module. If the respective spatial dimensions of a function module are smaller, the spatial dimensions of the function module or of the grid unit belonging to this function module can be increased correspondingly, for example adapted to the respective spatial dimensions of the at least one basic function module. These may be the smallest possible spatial dimensions.

It can be determined whether the respective spatial dimensions of the function modules that are adjacent to and/or follow in the vertical direction and/or lateral direction starting from the at least one basic function module are larger than the spatial dimensions assigned to the respective vertical direction and/or lateral direction of the at least one basic function module. If the respective spatial dimensions of a function module are larger, the spatial dimensions of the at least one basic function module or of the grid unit belonging to this basic function module can be increased correspondingly, for example adapted to the respective spatial dimensions of the largest function module present in the vertical direction or lateral direction, or to the respective spatial dimensions of the function module present in the vertical direction or lateral direction with the largest respective spatial dimensions assigned in the vertical direction or lateral direction. These may be the smallest possible spatial dimensions. The largest function module may be understood to be a function module with the largest spatial dimensions in the respective vertical direction and/or the lateral direction, such as greatest length, width and/or height.

Multiple function modules of the production system can be defined and/or designed on the basis of the specified requirements. The spatial dimensions for each function module may be or may have been defined based on the respective function module content and/or the respective function module process requirements. The spatial dimensions for each function module may be or may have been defined based on the design/formation of the functional elements of the respective function module and/or the relationships and/or arrangement of the functional elements, for example of the respective function module, with each other. The function module contents and/or the functional elements may be or may have been dimensioned based on the specified requirements and/or based on the respective function module process requirements. The function module content and/or the functional elements may include platforms such as operating platforms, lines such as pipelines, pipeline routes or pipeline guides, walkways, access areas, passage areas, maintenance areas, work areas, functional areas, escape areas/routes and/or rescue areas. Additionally or alternatively, the function module content and/or the functional elements may include air conditioning systems, ventilation systems, venting systems, fire protection systems such as sprinkler systems, and/or occupational safety devices such as emergency showers.

The smallest possible spatial dimension for each function module can be determined, for the respective function module process, for example. Additionally or alternatively, relationships between the function modules and/or within a function module can be determined, for example a functional relationship, a line flow relationship, a material flow relationship and/or a relationship of a logistics chain. The function modules may each be or may have been defined and/or designed based on the respective smallest possible spatial dimension determined and/or on the relationships.

The function modules and/or grid units may have standardised dimensions, based for example on their function module content and/or their function module elements. The standardised dimensions or standardised grid dimensions may be or may have been defined based on structure sizes prescribed by standards or guidelines. Additionally or alternatively, the standardised dimensions or standardised grid dimensions may be or may have been defined based on standardised sizes of trades and/or function modules. Standardised dimensions/grid dimensions of the function modules and/or grid units can be checked and/or adapted to the specified requirements. Standardised dimensions/grid dimensions of the function modules and/or grid units may be or may have been defined as described previously and/or in the following text.

If process and/or functional considerations allow it, heavy function modules such as heavy-duty function modules and/or force-introducing function modules and/or function modules presenting a risk of explosion may be or may have been arranged and/or grouped substantially directly next to or adjacent to each other in the lateral direction and/or substantially one above the other in the vertical direction. Heavy-duty function modules and/or force-introducing function modules may be for example silo modules, drivetrain modules, transmission modules, subprocess modules, pressure boosting system modules, granulation modules, granulation water system modules and/or granulate buffer container modules. The force-introducing function modules may be designed to generate and/or introduce/apply a force, e.g. rotational force, driving force or torque force, or a moment, e.g. torque or driving moment, to achieve a specific function, for example, such as turning a motor, driving processing screws, such as extruder screws, or driving a cutting head of a granulating apparatus, etc. The forces and/or moments may be relatively high. The force-introducing function modules may be designed to be supported on the foundation and/or on the three-dimensional framework. The force-introducing function modules may be designed to transfer or exert the force and/or moment onto the foundation and/or the three-dimensional framework, e.g. as a counterforce or counter-moment, in particular for supporting purposes.

Support points, for example supporting, bearing and/or fastening points, of the function modules may be or may have been provided. The support points, for example supporting, bearing and/or fastening points, of the function modules may be or may have been arranged and/or aligned at least partially on the defined grid.

A supporting structure, for example a frame-like supporting structure such as a three-dimensional supporting structure and/or a building supporting structure, may be planned and/or specified using the defined grid. The supporting structure may be the supporting structure or three-dimensional supporting structure of the production system. The supporting structure or three-dimensional supporting structure may be or may have been designed as described previously and/or in the following text.

At least one core area may be defined and/or specified. It may be defined and/or specified that the supporting structure has been or will be reinforced in the at least one core area and/or that the at least one core area has a reinforced foundation. Reinforced may be understood to mean a corresponding rigidity, such as bending rigidity and/or torsional rigidity, and/or strength and/or load-bearing capacity. At least one secondary area may be defined and/or specified, for example adjacent to the at least one core area. It may be defined and/or specified that in the at least one secondary area the supporting structure is or will be less reinforced compared to the supporting structure in the at least one core area and/or that the at least one secondary area has a foundation that is less reinforced compared to the foundation in the at least one core area. It may be defined and/or specified that in the at least one core area the three-dimensional supporting structure is or will be more rigid, for example more flexurally rigid and/or torsionally rigid, and/or with higher strength and/or with higher load-bearing capacity compared to the three-dimensional supporting structure in the at least one secondary area. It may be defined and/or specified that in the at least one core area the foundation is or will be designed with greater strength and/or with greater load-bearing capacity than the foundation in the at least one secondary area. An external area may be defined and/or specified, for example adjacent to the at least one core area and/or to the at least one secondary area. It may be defined and/or specified that no supporting structure is or will be provided in the at least one external area.

The selection of the function modules may be made from a collection and/or group of previously defined function modules, stored in a database for example.

The function modules may be or may have been selected from the following group: silo module, additive lift module, additive delivery module, additive dosing module, drivetrain module, transmission module, subprocess module, pressure boosting system module, granulation module, start-up system module, hot oil module, granulation water system module, granulate drying module, granulate screening module, granulate buffer container module, granulate removal module, maintenance module. Multiple equivalent or identical or substantially similar function modules and/or different function modules may be selected.

The grid and/or the height, such as maximum height or minimum height, of the grid and/or the width, such as maximum width or minimum width, of the grid and/or the length, such as maximum length or minimum length, of the grid, may be defined and/or determined based on an output, such as annual output and/or capacity, such as annual production capacity, of the production system, e.g. extrusion plant, and/or based on an output such as throughput per hour of the subprocess of the production line, e.g. the extruder of the extrusion plant.

At least one proportional factor may be prescribed or determined. The proportional factor may define and/or state the ratio between a height, such as maximum height or minimum height, width, such as maximum width or minimum width, or length, such as maximum length or minimum length, of the grid and a performance, such as annual performance or throughput, or capacity, such as annual production capacity, of the production system, e.g. extrusion plant, and/or of its subprocess, e.g. extruder. The grid or its height, width and/or length may be determined or defined based on the at least one proportional factor.

A production system, for example a modular production system, may be or may have been designed and/or created according to the method described previously and/or in the following text. The production system described previously and/or in the following text may be or may have been designed and/or created according to the method described previously and/or in the following text.

At least one function module or at least a part of a function module may be or may have been designed as a delivery module for transport to the place of use of the production system and/or as an assembly module for the operationally ready installation of the function module or function module part at the place of use of the production system.

The invention enables optimal positioning of the components or function modules relative to each other and/or optimal realisation or adaptation and/or alignment with the respective production process. Furthermore, the system outlay, planning outlay and/or planning time, in particular the investment costs but also the operating costs for the production system, may be reduced. Optimised logistics of the material flow and also line flow may be made possible, which can not only reduce the one-time acquisition and investment costs but can also be beneficial with regard to energy and the environment. Ongoing operating costs can be saved as a result, for example electricity for pneumatic conveying due to shorter paths or fewer line transitions that can lead to pressure loss. A space-saving construction, in particular with regard to footprint and/or space, may be achieved. Area consumption and/or energy consumption can be reduced significantly.

In the following, embodiments of the invention are described in greater detail with reference to schematic figures, which show for exemplary purposes:

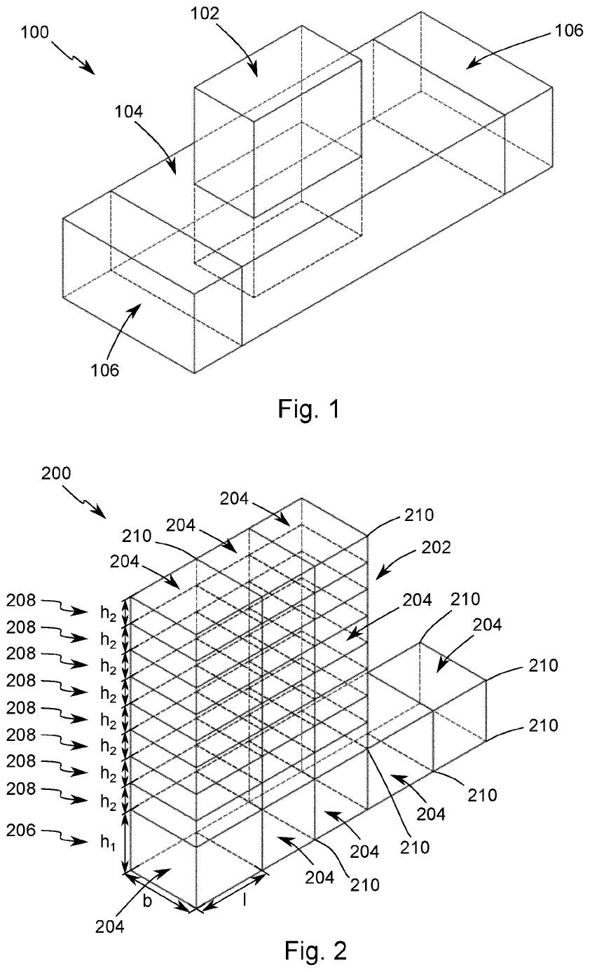

FIG. 1 a schematic representation of a modular production system;

FIG. 2 a variant of a core area of a modular production system;

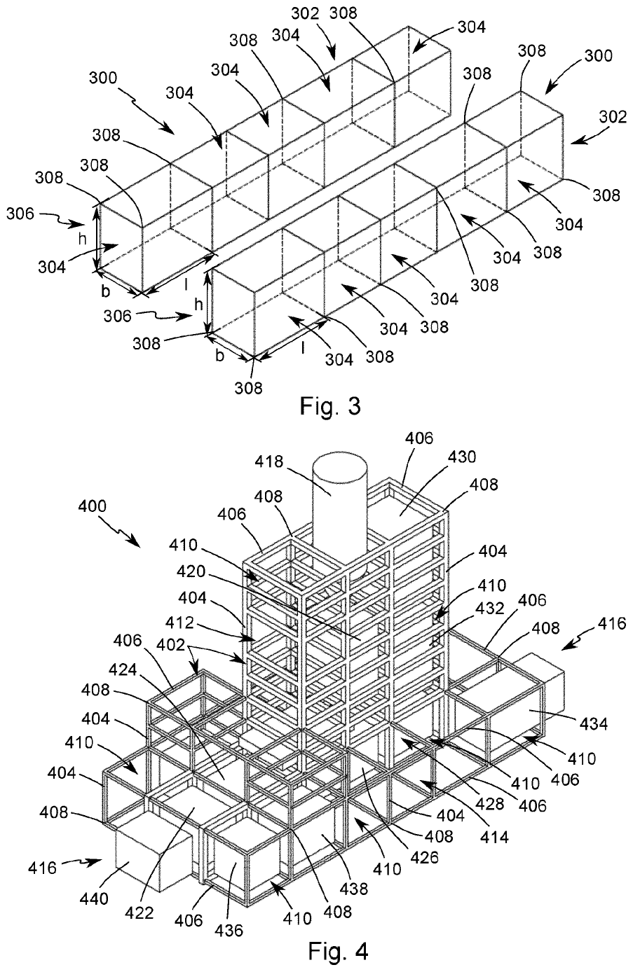

FIG. 3 a variant of a secondary area of a modular production system;

FIG. 4 a schematic representation of a modular production system with a three-dimensional framework in grid construction; and

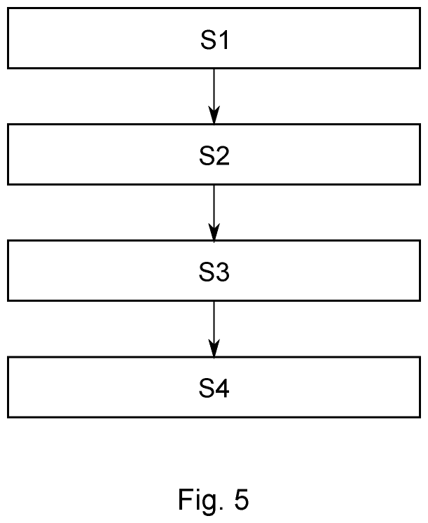

FIG. 5 a schematic flow chart of a method for designing a production system.

FIG. 1 shows a schematic representation of a modular production system 100 for processing material by means of extrusion. The production system comprises a plurality of function modules and a three-dimensional framework in a grid construction for accommodating the function modules (neither shown in FIG. 1), which are described in more detail below with reference to FIGS. 2 to 4. The three-dimensional framework may be designed for example as a steel structure with a plurality of vertically and horizontally arranged beams and struts, the connection points or connection positions of which are defined by the grid. Additionally or alternatively, the three-dimensional framework may be designed as a concrete structure and/or a wooden structure. The three-dimensional framework and/or its beams and struts may be made of steel and/or concrete and/or reinforced concrete and/or wood, for example. The grid of the three-dimensional framework, in particular the grid dimensions thereof, are defined at least in sections according to the spatial dimensions of the function modules and/or according to the relationships and/or arrangement and/or alignment of the function modules with respect to each other.

The function modules of the production system 100 comprise at least one function module from the following group: silo module, additive lift module, additive delivery module, additive dosing module, drivetrain module, transmission module, subprocess module, pressure boosting system module, granulation module, start-up system module, hot oil module, granulation water system module, granulate drying module, granulate screening module, granulate buffer container module, granulate removal module, maintenance module.

The production system 100 according to FIG. 1 further comprises several areas or is divided into several areas. In the present embodiment, the production system 100 has a core area 102, a secondary area 104 and two external areas 106.

In the core area 102, the three-dimensional framework of the production system 100 is of reinforced construction, wherein for example the beams and struts of the steel framework in the core area 102 are reinforced compared to the beams and struts in other areas of the steel framework. In the core area 102, for example, the beams and struts of the steel framework may have a larger and/or more resilient cross-section than the beams and struts in other areas of the steel framework and can therefore withstand a greater load. For example, the beams and struts of the steel framework in the core area 102 may be rigid, for example flexurally and/or torsionally more rigid, and/or have greater strength and/or with greater load-bearing capacity than the beams and struts in other areas of the steel framework. Moreover, the core area 102 has a reinforced foundation on the floor. In the core area 102, at least one or more function modules may be arranged, selected from the following group: silo module, additive delivery module, additive dosing module, drivetrain module, transmission module, subprocess module, pressure boosting system module, granulation module, granulate drying module, granulate screening module, granulate buffer container module, granulate removal module.

The secondary area 104 is directly adjacent to the core area 102. In the present embodiment according to FIG. 1, the secondary area 104 surrounds the core area, wherein a part of the core area 102 projects upwards, in the vertical direction. In the secondary area 104, the three-dimensional framework is less reinforced than the three-dimensional framework in the core area 102. The beams and struts of the steel structure in the secondary area 104 may, for example, have a smaller and/or less resilient cross-section than the beams and struts in the core area 102 of the steel structure. In the core area 102, the beams and struts of the steel structure may be more rigid, for example more flexurally rigid and/or more torsionally rigid, and/or have greater strength and/or greater load-bearing capacity, than the beams and struts of the steel structure in the secondary area 104. Furthermore, the secondary area 104 has a foundation on the floor that is less reinforced than the foundation in the core area 102. In the core area 102, the foundation may be constructed with greater strength and/or greater load-bearing capacity than the foundation in the secondary area 104. For example, the foundation in the core area 102 may be or comprise a thicker floor slab than the foundation in the secondary area 104 and/or have more steel inserts/reinforcements. At least one or more function modules may be arranged in the secondary area, selected from the following group: additive lift module, additive delivery module, additive dosing module, subprocess module, pressure boosting system module, granulation module, hot oil module, granulation water system module, granulate drying module, granulate screening module, granulate buffer container module, granulate removal module, maintenance module.

The two external areas 106 are directly adjacent to the secondary area. In the present embodiment according to FIG. 1, the two external areas 106 are arranged on opposite sides of the secondary area 104. No three-dimensional framework is provided in the external areas 106. Depending on the requirements, a foundation may be provided on the ground in the external areas 106. The foundation of the external areas 106 may be equivalent to the foundation of the secondary area 104. However, a foundation in the external area 106 is not always essential and may or may not be provided depending on requirements. The external areas 106 may be located partially or completely outside the building in which the production system is arranged. For example, at least one or more function modules may be arranged in the external areas 106, selected from the following group: additive delivery module, start-up system module, hot oil module, granulation water system module. In particular, at least one or more function modules may be arranged in a first, lowest level of the external areas 106, selected from the following group: start-up system module, hot oil module, granulation water system module.

FIG. 2 shows a variant of a core area 200 of a modular production system. The core area 200 is, for example, substantially L-shaped and has a three-dimensional framework in grid construction, wherein the grid 202 has several grid units 204, each with a grid length I, grid width b and grid height h. The grid length I, grid width b and/or grid height h of at least one grid unit 204 may substantially correspond to the spatial dimension of a function module arranged in the grid unit 204. The grid length I and/or grid width b may additionally or alternatively be specified depending on the function module. The grid height h may additionally or alternatively be specified in accordance with construction constraints. The grid dimensions of the grid 202 and also the spatial dimensions of the function modules may be designed at least partially as standardised dimensions or grid dimensions.

In the present embodiment according to FIG. 2, the grid lengths I and grid widths b of grid units 204 arranged one above the other in the height direction, in particular substantially vertically one above the other, are all substantially the same. The three-dimensional framework or the grid has a first, in this case lowest, level 206 with a first minimum height or minimum grid height h₁ and several second levels 208 arranged and constructed on top of the first level 206 (in FIG. 2, for example, eight second levels 208), each with a second minimum height or minimum grid height h₂. The first minimum grid height h₁ of the first level 206 is greater than the respective second minimum grid heights h₂ of the second levels 208. The multiple second levels 208 here all have the same second minimum grid height h₂. For example, the minimum grid height h₁ of the first level 206 is approximately 6.0 to 10.0 m and the second minimum grid heights h₂ of the second levels 208 are each approximately 3.0 to 5.0 m. In the embodiment according to FIG. 2, the minimum grid height h₁ of the first level 206 is approximately 8.0 m and the second minimum grid heights h₂ of the second levels 208 are each approximately 3.5 m.

The grid points of the grid 202 shown in FIG. 2 may be defined by the notional connection points or connection positions 210 of the vertical and horizontal lines as represented. For example, the lines may represent the axes of the vertically and horizontally arranged beams and struts of the three-dimensional framework and/or define their position and/or orientation.

In the core area 200, at least one or more function modules may be arranged, selected from the following group: silo module, additive delivery module, additive dosing module, drivetrain module, transmission module, subprocess module, pressure boosting system module, granulation module, granulate drying module, granulate screening module, granulate buffer container module, granulate removal module. In particular, at least one or more function modules may be arranged in the first, lowest level 206 of the core area 200, selected from the following group: drivetrain module, transmission module, subprocess module, pressure boosting system module, granulation module.

Otherwise, reference is made in particular to FIG. 1 and the associated description.

FIG. 3 shows a variant of a secondary area 300 of a modular production system. Two secondary areas 300 are shown in FIG. 3. The production system may have at least one secondary area, but also several, for example two or more secondary areas. These may be different or substantially the same secondary areas.

The secondary areas 300 are, for example, substantially I-shaped and have a three-dimensional framework in grid construction, wherein the grid 302 includes several grid units 304, each with a grid length I, grid width b and grid height h. The grid length I, grid width b and/or grid height h of at least one grid unit 304 may substantially correspond to the spatial dimension of a function module arranged in the grid unit 304. The grid length I and/or grid width b may additionally or alternatively be specified depending on the function module. The grid height h may additionally or alternatively be specified according to construction constraints. The grid dimensions of the grid 302 but also the spatial dimensions of the function modules may be designed at least partially as standardised dimensions or grid dimensions. In the present embodiment according to FIG. 3, the grid units 304 of the secondary areas 300 are all arranged in one level 306, for example the lowest level. Additionally or alternatively, at least some grid units may also be provided which are arranged one above the other in the height direction, in particular substantially vertically one above the other (as shown in FIG. 4, for example). Thus, several, for example two, three or more, levels, such as height levels, may also be provided in the secondary area 300. The first minimum grid height of a first, lowest level of the secondary area 300 and/or the second minimum grid height(s) of the at least one or more second levels of the secondary area 300 arranged and constructed on the first level may be designed and/or defined as described above with reference to FIG. 2.

The grid points of the grid 302 shown in FIG. 3 may be defined by the notional connection points or connection positions 308 of the vertical and horizontal lines as represented. For example, the lines may represent the axes of the vertically and horizontally arranged beams and struts of the three-dimensional structure and/or define their position and/or orientation.

In the secondary area 300, at least one or more function modules may be arranged, selected from the following group: additive lift module, additive delivery module, additive dosing module, subprocess module, pressure boosting system module, granulation module, hot oil module, granulation water system module, granulate drying module, granulate screening module, granulate buffer container module, granulate removal module, maintenance module. In particular, at least one or more function modules may be arranged in the first, lowest level 306 of the secondary area 300, selected from the following group: additive lift module, subprocess module, pressure boosting system module, granulation module, hot oil module, granulation water system module, maintenance module. The additive lift module may also extend over several levels, in particular in the vertical direction.

Otherwise, reference is made in particular to FIGS. 1 and 2 and the associated description for additional information.

FIG. 4 is a schematic representation of a modular production system 400 with a three-dimensional framework 402 in grid construction. The production system 400 is designed and configured for processing material by means of extrusion. The three-dimensional framework 402 is designed as a steel framework and serves to accommodate a plurality of function modules of the production system 400. The steel framework includes a plurality of vertically arranged supports 404 and a plurality of horizontally arranged struts 406, which are made of steel. Additionally or alternatively, the three-dimensional framework 402 may be designed as a concrete structure and/or a wooden framework. The three-dimensional framework 402 and/or its beams and struts may be made of steel and/or concrete and/or reinforced concrete and/or wood, for example. The connection points or connection positions 408 of the beams and struts, which are in particular notional, are defined by the grid and the grid points thereof. The grid includes several, in particular notional, grid units 410, wherein the grid or the grid units 410 thereof may be designed as described previously and/or in the following text. Grid units 410 may also extend over several, for example two, in particular adjacent grid units 410, as shown for example in FIG. 4. The steel framework is thus composed of cubic and cuboid-shaped grid units 410 which are formed by means of the supports 404 and struts 406.

The production system 400 comprises a plurality of function modules which were selected based on specified requirements, for example process and/or method requirements, applicable to a plant concept of the production system 400. The grid of the three-dimensional framework 402, in particular the grid dimensions thereof, is/are specified and/or defined at least in sections taking into account the specified requirements and/or in accordance with the spatial dimensions of the selected function modules and/or in accordance with the relationships and/or arrangement and/or alignment of the selected function modules with respect to each other. The individual function modules are arranged and aligned on the specified and defined grid.

The production system 400 has a core area 412, at least one secondary area 414 directly adjacent to the core area 412 and two external areas 416 directly adjacent to the secondary area 414.

In the core area 412, the steel supporting structure is reinforced, wherein the beams 404 and struts 406 of the steel supporting structure are reinforced compared to the beams 404 and struts 406 in the secondary area 414. As may be seen in FIG. 4, the beams 404 and struts 406 of the steel supporting structure in the core area 412 may have a larger and/or more resilient cross-section than the beams 404 and struts 406 in the secondary area 414. In the core area 412, the beams and struts of the steel supporting structure are more rigid, for example more flexurally rigid and/or more torsionally rigid, and/or have greater strength and/or greater resilience compared to the beams and struts of the steel supporting structure in the secondary area 414. As a result, the beams 404 and struts 406 of the steel supporting structure in the core area can support greater loads. Furthermore, a reinforced foundation is provided on the floor in the core area 412. In the core area 412, the foundation may be designed with greater strength and/or with greater load-bearing capacity than the foundation in the secondary area 414. For example, the foundation in the core area 412 may be or comprise a thicker base plate than the foundation in the secondary area 414 and/or have more steel inserts/reinforcements. In the embodiment according to FIG. 4, a silo module 418, an additive delivery module (not shown), an additive dosing module 420, a drivetrain module 422, a transmission module 424, a subprocess module 426, a pressure boosting system module (not shown), a granulation module 428, a granulate drying and screening module 430, a granulate buffer container module 432, and a granulate removal module (not shown) are arranged relative to one another in the core area 412 for effective and functional reasons. The silo module 418 extends vertically through several levels, and in the topmost area of the production system 400 protrudes vertically above the last level. The additive dosing module 420 also extends vertically through several levels and is located in a central area of the production system 400. The drivetrain module 422, transmission module 424, subprocess module 426, pressure boosting system module and a granulation module 428 are located on the first, lowest level and are arranged substantially one after the other in the process direction. The granulate drying and screening module 430 and granulate buffer container module 432 extend through several levels in the vertical direction and are arranged in an area on the side of the production system 400.

In the secondary area 414, the beams 404 and struts 406 of the three-dimensional framework 402 are less reinforced than the beams 404 and struts 406 in the core area 412. As shown in FIG. 4, the beams 404 and struts 406 of the steel structure in the secondary area 414 may have a smaller and/or less resilient cross-section than the beams 404 and struts 406 in the core area 412 of the steel structure. Further, a foundation is provided on the floor in the secondary area 414, which is less reinforced and less resilient than the foundation in the core area 412. In the embodiment according to FIG. 4, an additive lift module (not shown), a granulating water system module 434 extending into the external area 416, a motor maintenance module 436 and a transmission maintenance module 438 are arranged in the secondary area 414 relative to one another for effective and functional purposes. The additive lift module extends through several levels in the vertical direction. The granulating water system module 434, motor maintenance module 436 and transmission maintenance module 438 are located on the first, lowest level.

The two external areas 416 are arranged on opposite sides of the secondary area 414 and do not have a three-dimensional framework 402. The external areas 416 may be located partially or entirely outside the building in which the production system 400 is arranged. In the embodiment according to FIG. 4, a hot oil module 440 and, in sections, the granulation water system module 434 are arranged in the external areas 416 for effective and functional purposes. The hot oil module 440 and the granulation water system module 434 are located on the first, lowest level.

The production system 400 may be designed and/or realised by means of a method as described previously and/or in the following text.

Otherwise, reference is made in particular to FIGS. 1 to 3 and the associated description for additional information.

FIG. 5 shows a schematic flow diagram of a method for designing a production system, for example a modular production system. The production system may be designed and/or configured to process material by means of extrusion. The production system may be designed as described previously and/or in the following text.

In a first step S1, requirements, in particular process and/or method requirements applicable to a plant concept of the production system to be planned are defined.

In a second step S2, several function modules are selected based on the specified requirements.

The function modules may be selected from the following group: silo module, additive lift module, additive delivery module, additive dosing module, drivetrain module, transmission module, subprocess module, pressure boosting system module, granulation module, start-up system module, hot oil module, granulation water system module, granulate drying module, granulate screening module, granulate buffer container module, granulate removal module, maintenance module.

In a third step S3, a grid, in particular a system and/or building grid, is defined taking into account the specified requirements and/or spatial dimensions of the selected function modules and/or the relationships and/or arrangement and/or alignment of the selected function modules with respect to each another.

Defining the grid includes determining grid units, each with a grid length, grid width and grid height. The grid length and grid width are specified depending on the function module. The grid height is specified according to construction constraints. Defining the grid further includes determining several levels with minimum heights, in particular minimum grid heights. The minimum heights of the levels may be specified in accordance with construction constraints and/or defined based on the spatial dimension, in particular height, of at least one function module provided on the respective level, and/or based on the specified requirements.

Defining the grid may further comprise determining a first level with a first minimum height, in particular minimum grid height, and at least one second level with a second minimum height, in particular minimum grid height, wherein the first minimum height of the first level is greater than the second minimum height of the at least one second level.

In a fourth step S4, the selected function modules are arranged and aligned on the defined grid.

The grid is defined in such a way and the function modules are arranged and aligned on the defined grid in such a way that the function, such as the overall function, of the production system and the respective function modules and the relationships between the function modules are assured. Heavy function modules, such as heavy-duty function modules, and/or force-introducing function modules, and/or function modules presenting a risk of explosion, may be arranged substantially directly next to or adjacent to each other laterally and/or substantially one above the other in the vertical direction if process and functional considerations permit. Support points, in particular support, bearing and/or fastening points of the function modules may be arranged and aligned at least partially on the defined grid.

With the method, a supporting structure, in particular a frame-like structure such as a three-dimensional supporting structure and/or a building supporting structure, may also be planned and defined by means of the defined grid.

With the method, at least one core area may also be defined in which the supporting structure is reinforced and which has a reinforced foundation. Additionally, at least one secondary area, in particular adjacent to the at least one core area, may be defined in which the supporting structure is less reinforced than the supporting structure in the at least one core area, and which has a foundation that is less reinforced than the foundation in at least one core area. In this case, it may be defined and/or specified that the supporting structure in the at least one core area has been or will be designed to be more rigid, for example more flexurally and/or torsionally rigid, and/or with greater strength and/or with greater load-bearing capacity, than the supporting structure in the at least one secondary area. It may further be defined and/or specified that the foundation in the at least one core area has been or will be designed to be stronger and/or have greater load-bearing capacity than the foundation in at least one secondary area. Furthermore, at least one external area may be defined, in particular adjacent to the at least one core area and/or to the at least one secondary area, in which a supporting structure is not provided.

Otherwise, reference is made in particular to FIGS. 1 to 4 and the associated description for additional information.

The word “may” refers in particular to optional features of the invention. It follows that there are also further developments and/or embodiments of the invention which additionally or alternatively include the respective feature or features.

If necessary, individual features may also be selected from the feature combinations disclosed here and used in combination with other features to define the subject matter of the claim, cancelling any structural and/or functional relationship that may exist between the features. The sequence and/or number of steps of the method may be varied.

### LIST OF REFERENCE SYMBOLS

100 Production system
102 Core area
104 Secondary area
106 External area
200 Core area
202 Grid
204 Grid units
206 First/bottom level
208 Second levels
210 Connection points/grid points
300 Secondary area
302 Grid
304 Grid units
306 Level
308 connection points/grid points
400 Production system
402 Three-dimensional framework
404 Support
406 Strut
408 Connection points/grid points
410 Grid units
412 Core area
414 Secondary area
416 External areas
418 Silo module
420 Additive dosing module
422 Drivetrain module
424 Transmission module
426 Subprocess module
428 Granulation module
430 Granulate drying and screening module
432 Granulate buffer container module
434 Granulating water system module
436 Motor maintenance module
438 Transmission maintenance module
440 Hot oil module
S1 Step for specifying requirements
S2 Step for selecting function modules
S3 Step for defining the grid
S4 Step for arranging and aligning the function modules on the grid
l Grid length
b Grid width
h Grid height
h₁ First minimum grid height
h₂ Second minimum grid height

1. Modular production system (100, 400) for processing material by means of extrusion, comprising a plurality of function modules (418-440) and a three-dimensional framework (402) in a grid construction for receiving the function modules (418-440), wherein the grid (202, 302) of the three-dimensional framework (402), in particular the grid dimensions thereof, is defined at least in sections according to the spatial dimensions of the function modules (418-440) and/or according to the relationships and/or arrangement and/or alignment of the function modules (418-440) with respect to each other.

2. Modular production system (100, 400) according to claim 1, characterized in that the dimensions and/or the grid dimensions of the grid (202, 302) and/or the spatial dimensions of the function modules (418-440) are at least partially designed as standardised dimensions and grid dimensions.

3. Modular production system (100, 400) according to at least one of the preceding claims, characterized in that the grid (202, 302) includes a plurality of grid units (204, 304, 410), each having a grid length (I), grid width (b) and grid height (h, h₁, h₂), wherein the grid length (I), grid width (b) and/or grid height (h, h₁, h₂) of at least one grid unit (204, 304, 410) substantially corresponds to the spatial dimension of a function module (418-440) arranged in the grid unit (204, 304, 410), and/or wherein the grid length (I) and/or grid width (b) is specified according to the function module and/or the grid height (h, h₁, h₂) is specified in accordance with construction constraints.

4. Modular production system (100, 400) according to at least one of the preceding claims, characterized in that the grid (202, 302) includes a plurality of grid units (204, 304, 410), each having a grid length (I), grid width (b) and grid height (h, h₁, h₂), wherein the grid lengths (I) and/or grid widths (b) of grid units (204, 304, 410) arranged one above the other in the height direction, in particular substantially vertically one above the other, are substantially all the same and/or substantially correspond to the length or width of the function module (418-440) with the greatest length or width arranged in this height direction.

5. Modular production system (100, 400) according to at least one of the preceding claims, characterized in that at least one function module (418-440) extends substantially over one, two or more grid units (204, 304, 410).

6. Modular production system (100, 400) according to at least one of the preceding claims, characterized in that the three-dimensional framework (402) and/or the grid (202, 302) thereof has a first, in particular lowest, level (206, 306) with a first minimum height (h₁), in particular minimum grid height, and at least one second level (208) arranged and/or constructed on the first level (206, 306) with a second minimum height (h₂), in particular minimum grid height.

7. Modular production system (100, 400) according to claim 6, characterized in that the first minimum height (h₁) of the first level (206, 306) is greater than the second minimum height (h₂) of the at least one second level (208).

8. Modular production system (100, 400) according to claim 6 or 7, characterized in that several second levels (208) arranged and/or constructed one above the other are provided, wherein the several second levels (208) all have the same second minimum height (h₂).

9. Modular production system (100, 400) according to at least one of the preceding claims 6 to 8, characterized in that the first minimum height (h₁) of the first level is approximately 6.0 to 10.0 m, preferably approximately 8.0 m, and/or that the second minimum height (h₂) of the at least one second level is approximately 3.0 to 5.0 m, preferably approximately 3.5 m.

10. Modular production system (100, 400) according to at least one of the preceding claims, characterized in that the function modules (418-440) comprise at least one function module (418-440) from the following group: silo module (418), additive lift module, additive delivery module, additive dosing module (420), drivetrain module (422), transmission module (424), subprocess module (426), pressure boosting system module, granulation module (428), start-up system module, hot oil module (440), granulation water system module (434), granulate drying module (430), granulate screening module (430), granulate buffer container module (432), granulate removal module, maintenance module (436, 438).

11. Modular production system (100, 400) according to at least one of the preceding claims, characterized in that at least one core area (102, 200, 412) is provided, in which the three-dimensional framework (402) is reinforced and/or which has a reinforced foundation.

12. Modular production system (100, 400) according to claim 11, characterized in that at least one secondary area (104, 300, 414) is provided, in particular adjacent to the at least one core area (102, 200, 412), in which secondary area the three-dimensional framework (402) is less reinforced than the three-dimensional framework (402) in the at least one core area (102, 200, 412) and/or which has a less reinforced foundation than the foundation in the at least one core area (102, 200, 412).

13. Modular production system (100, 400) according to claim 11 or 12, characterized in that at least one external area (106, 416) is provided, in particular adjacent to the at least one core area (102, 200, 412) and/or secondary area (104, 300, 414), in which no three-dimensional framework (402) is arranged.

14. Modular production system (100, 400) according to at least one of the preceding claims 11 to 13, characterized in that at least one or more function modules (418-440) are arranged in the at least one core area (102, 200, 412), selected from the following group: silo module (418), additive delivery module, additive dosing module (420), drivetrain module (422), transmission module (424), subprocess module (426), pressure boosting system module, granulation module (428), granulate drying module (430), granulate screening module (430), granulate buffer container module (432), granulate removal module.

15. Modular production system (100, 400) according to at least one of the preceding claims 12 to 14, characterized in that at least one or more function modules (418-440) are arranged in the at least one secondary area (104, 300,0 414), selected from the following group: additive lift module, additive delivery module, additive dosing module (420)), subprocess module (426), pressure boosting system module, granulation module (428), hot oil module (440), granulation water system module (434), granulate drying module (430), granulate screening module (430), granulate buffer container module (432), granulate removal module, maintenance module (436, 438).

16. Modular production system (100, 400) according to at least one of the preceding claims 13 to 15, characterized in that at least one or more function modules (418-440) are arranged in the at least one external area (106, 416), selected from the following group: additive delivery module, start-up system module, hot oil module (440), granulation water system module (434).

17. Modular production system (100, 400) according to at least one of the preceding claims, characterized in that at least one or more function modules (418-440) are arranged in the first level (206, 306), selected from the following group: additive lift module, drivetrain module (422), transmission module (424), subprocess module (426), pressure boosting system module, granulation module (424), start-up system module, hot oil module (440), granulation water system module (434), maintenance module (436, 438).

18. Method for designing a production system (100, 400) for processing material by means of extrusion, in particular a production system (100, 400) according to at least one of the preceding claims, comprising at least the following steps:
Specifying (S1) requirements, in particular process and/or method requirements, applicable to a plant concept of the production system to be planned (100, 400);
Selecting (S2) a plurality of several function modules (418-440) based on the specified requirements;
Defining (S3) a grid (202, 302), in particular a system grid and/or building grid, taking into account the specified requirements and/or spatial dimensions of the selected function modules (418-440) and/or the relationships and/or arrangement and/or alignment of the selected function modules (418-440) with respect to each other; and
Arranging and/or aligning (S4) the selected function modules (418-440) on the defined grid (202, 302).

19. Method according to claim 18, characterized in that the grid (202, 302) is defined in such a way and/or that the function modules (418-440) are arranged and/or aligned on the defined grid (202, 302) in such a way that the function, such as overall function, of the production system (100, 400) and/or of the respective function modules (418-440) and/or relationships of the function modules (418-440) with each other is/are assured.

20. Method according to at least one of the preceding claims 18 to 19, characterized in that the definition (S3) of the grid (202, 302) includes determining grid units (204, 304, 410) each having a grid length (I), grid width (b) and grid height (h, h₁, h₂), wherein the grid length (I) and/or grid width (b) is/are specified depending on the function module and/or the grid height (h, h₁, h₂) is specified according to construction constraints, and/or that the definition (S3) of the grid (202, 302) comprises determining a plurality of levels (206, 208, 306) with minimum heights (h, h₁, h₂), in particular minimum grid heights, wherein the minimum heights (h, h₁, h₂) of the levels (206, 208, 306) are determined on the basis of construction constraints, based on the spatial dimension, in particular height, of at least one function module (418-440) provided on the respective level (206, 208, 306) and/or determined and/or defined based on the specified requirements and/or that the definition (S3) of the grid (202, 302) comprises determining a first level (206, 306) with a first minimum height (h₁), in particular minimum grid height, and at least one second level (208) with a second minimum height (h₂), in particular minimum grid height, wherein the first minimum height (h₁) of the first level (206, 306) is greater than the second minimum height (h₂) of the at least one second level

(208) .

21. Method according to at least one of the preceding claims 18 to 20, characterized in that heavy function modules (418-440), such as heavy-duty function modules, and/or force-introducing function modules, and/or function modules presenting a risk of explosion, have been or will be arranged substantially directly next to or adjacent to each other laterally and/or substantially one above the other in the vertical direction if process and functional considerations allow.

22. Method according to at least one of the preceding claims 18 to 21, characterized in that support points, in particular support, bearing and/or fastening points, of the function modules (418-440) are or will be arranged and/or aligned at least partially on the defined grid (202, 302).

23. Method according to at least one of the preceding claims 18 to 22, characterized in that a supporting structure (402), in particular a frame-like supporting structure, such as a three-dimensional supporting structure and/or a building supporting structure, is planned and/or specified by means of the defined grid (202, 302).

24. Method according to claim 23, characterized in that at least one core area (102, 200, 412) is defined in which the supporting structure (402) is or will be reinforced and/or which has a reinforced foundation, that at least one secondary area (104, 300, 414), in particular adjacent to the at least one core area (102, 200, 412), is defined in which the supporting structure (402) is or will be less reinforced compared to the supporting structure (402) in the at least one core area (102, 200, 412) and/or which has a less reinforced foundation compared to the foundation in the at least one core area (102, 200, 412), and that at least one external area (106, 416) is defined, in particular adjacent to the at least one core area (102, 200, 412) and/or to the at least one secondary area (104, 300, 414), in which a supporting structure (402) is not or will not be provided.

25. Method according to at least one of the preceding claims 18 to 24, characterized in that the function modules (418-440) have been or will be selected from the following group: silo module (418), additive lift module, additive delivery module, additive dosing module (420), drivetrain module (422), transmission module (424), subprocess module (426), pressure boosting system module, granulation module (428), start-up system module, hot oil module (440), granulation water system module (434), granulate drying module (430), granulate screening module (430), granulate buffer container module (432), granulate removal module, maintenance module (436, 438).

26. Modular production system (100, 400) for processing material by means of extrusion, in particular production system (100, 400) according to at least one of the preceding claims 1 to 17, characterized in that the production system (100, 400) is designed and/or created according to a method according to at least one of the preceding claims 18 to 25.
